(19) United States
(12) Patent Application Publication
(10) Pub. No.: US 2026/0045618 A1
(43) Pub. Date: Feb. 12, 2026

(54) ESS RACK ANCHORING DEVICE AND ANCHORING METHOD

(71) Applicant: Samsung SDI Co., Ltd., Yongin-si (KR)

(72) Inventor: Jaeyong Cho, Yongin-si (KR)

(73) Assignee: Samsung SDI Co., Ltd., Yongin-si (KR)

(21) Appl. No.: 19/283,914

(22) Filed: Jul. 29, 2025

(30) Foreign Application Priority Data
Aug. 6, 2024 (KR) 10-2024-0104979

(51) Int. Cl. H01M 50/262

(52) U.S. Cl. CPC H01M 50/262

(57) ABSTRACT

The present disclosure relates to an energy storage system (ESS) rack anchoring device and anchoring method which enable: an anchoring process of a rack to be simple, a plurality of racks to be consecutively disposed densely, and strong fixation to a floor to be maintained so that the rack is stably supported even when shaking such as an earthquake occurs. The anchoring device may include an anchor beam fixed to a floor of a space in which a rack for accommodating a battery module is disposed and providing support strength, an insert body positioned at one side of the rack and supported by being pressed by the anchor beam to prevent lifting, a floor fixing body in contact with the floor in a state in which the insert body is supported by the anchor beam, and a floor fixing part fixing the floor fixing body to the floor.

### CROSS-REFERENCE TO RELATED APPLICATIONS

This present application claims priority to and the benefit under 35 U.S.C. § 119(a)-(d) of Korean Patent Application No. 10-2024-0104979, filed on Aug. 6, 2024, in the Korean Intellectual Property Office, the entire disclosure of which is incorporated herein by reference.

### FIELD

The present disclosure relates to an anchoring device and anchoring method.

### BACKGROUND

Different from primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. These batteries include an electrode assembly comprising a positive electrode and a negative electrode, a case housing the electrode assembly, and terminals connected to the electrode assembly.

The above information disclosed in this Background section is for enhancement of understanding of the background of the present disclosure, and therefore, it may contain information that does not constitute a related (or prior) art.

### SUMMARY

According to the present disclosure, an anchoring process of a rack can be simple, and a plurality of racks may be consecutively disposed densely. In addition, the present disclosure is directed to providing an energy storage system (ESS) rack anchoring device and anchoring method which can enable a rack to be stably maintained even when shaking such as an earthquake occurs because a strong fixation to the floor is maintained.

An ESS rack anchoring device according to some aspects of the present disclosure includes an anchor beam fixed to a floor of a space in which a rack for accommodating a battery module is disposed and providing support strength, an insert body positioned at one side of the rack and supported by being pressed by the anchor beam to prevent lifting, a floor fixing body in contact with the floor in a state in which the insert body is supported by the anchor beam, and a floor fixing part fixing the floor fixing body to the floor.

According to some embodiments, the anchor beam has a body pressing portion that provides a restraining space between the body pressing portion and a floor surface of the floor and is configured to support the insert body accommodated in the restraining space.

According to some embodiments, the insert body is horizontally formed to protrude outward from the rack to be inserted into the restraining space or withdrawn from the restraining space through a horizontal movement of the rack.

According to some embodiments, a buried groove is formed in the floor of the space, the anchor beam is seated in the buried groove and seated so that the body pressing portion protrudes upward from the buried groove, and a beam fixing part fixing the anchor beam in the buried groove is provided in the buried groove.

According to some embodiments, the anchor beam has one of I-shaped and ⊂-shaped cross sections, wherein the ⊂-shaped cross section includes a C shape with sharp corners.

In addition, an ESS rack anchoring device according to other aspects of the present disclosure includes an anchor unit having a base fixed to a floor of a space in which a rack for accommodating a battery module is disposed, and a supporter installed such that a position thereof is adjustable on the base and providing support strength, an insert body fixed to one side of the rack and supported by an anchor module to prevent lifting from the floor, a floor fixing body in contact with the floor in a state in which the insert body is supported by the anchor module, and a floor fixing part fixing the floor fixing body to the floor.

According to some embodiments, the base is a beam extending in a longitudinal direction and has a holder, and the supporter is a pressing plate that is disposed horizontally on the holder and supports the insert body while being fixed to an upper end of the holder through a pressing bolt.

According to some embodiments, a buried groove is formed in the floor of the space, the base of the anchor unit is seated in the buried groove and seated so that an upper end portion of the holder protrudes upward from the buried groove, and a base fixing part fixing the base in the buried groove is provided inside the buried groove.

According to some embodiments, the base provides a space portion that opens upward, the supporter includes an elevating body that is movable upward and downward on the base in a state in which a portion thereof is accommodated in the space portion, and an electric elevating mechanism configured to move the elevating body upward and downward is installed in the space portion of the base.

According to some embodiments, a pressing portion configured to press and support the insert body is provided on a side portion of the elevating body, and the elevating mechanism is configured to move the elevating body downward so that the pressing portion supports the insert body.

According to some embodiments, the elevating mechanism has a motor, a motor controller configured to control the motor, and a lead screw axially rotated by receiving a rotational force of the motor and installed vertically, and a female screw hole configured to engage with the lead screw is provided in the elevating mechanism.

According to some embodiments, the anchor unit is further provided with a communication module which is configured to access the elevating mechanism and transmit an external control signal to a motor controller to adjust a height of the elevating body.

According to some embodiments, a buried groove is formed in the floor of the space, and the base is seated in the buried groove, and a base fixing part is provided in the buried groove to fix the base, wherein an upper end portion of the base is positioned on a same plane as the floor.

According to some embodiments, the base has a shape of a linearly extending block, and has a fixing hole that opens upward, and the supporter is an elastic pressing plate of which a portion elastically presses and supports the insert body from an outside area of the base while being supported by the fixing hole.

According to some embodiments, a support sawteeth portion is formed inside the fixing hole, and the elastic pressing plate has an extension supported by being accommodated in the fixing hole, and an elastic pressing portion that is formed integrally with an upper end of the extension, has a bent shape, and supports the insert body.

According to some embodiments, a buried groove is formed in the floor of the space, the base is seated in the buried groove, and a base fixing part is provided in the buried groove to support the base, wherein an upper end portion of the base is positioned on a same plane as the floor.

In addition, an anchoring method according to still other aspects of the present disclosure includes a buried groove forming operation in which a buried groove is formed in a floor of a space in which a rack for accommodating a battery module is disposed, an anchor beam seating operation in which an anchor beam providing support strength is installed in the buried groove, an anchor beam fixing operation in which the anchor beam is fixed in the buried groove, a rack position adjusting operation in which a position of the rack with respect to the fixed anchor beam is adjusted, and a rack fixing operation in which the rack of which the position is adjusted is moved to the anchor beam to support the rack on the anchor beam.

According to some embodiments, an insert body is provided on one side of a lower end portion of the rack, and a floor fixing body coupled to the floor is installed on the other side thereof, and the rack fixing operation includes a process of installing the floor fixing body on the floor in a state in which the insert body is supported by being engaged with the anchor beam.

According to some embodiments, fixing the anchor beam includes a process of pouring mortar in the buried groove in which the anchor beam is seated.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

The following drawings accompanying the present specification illustrate embodiments of the present disclosure and further describe aspects and features of the present disclosure together with the detailed description of the present disclosure. Thus, the present disclosure should not be construed as being limited to the drawings, in which:

FIG. 1 schematically illustrates a pouch-type battery.

FIG. 2 is a cross-sectional view of a cylindrical battery.

FIG. 3A is a top perspective view showing the appearance of a square battery.

FIG. 3B is a cross-sectional view taken along line A-A of FIG. 3a.

FIG. 4 is an example diagram of a battery module in which batteries are arranged.

FIG. 5 is a plan view of an energy storage to which an energy storage system (ESS) rack anchoring device according to some embodiments of the present disclosure is applied;

FIG. 6 is a view showing one example of the rack shown in FIG. 5;

FIGS. 7A and 7B are perspective views separately showing a floor fixing structure of FIG. 6;

FIGS. 8 and 9 are configuration diagrams showing an anchoring device according to some embodiments of the present disclosure;

FIGS. 10 and 11 are views showing another example of the anchoring device according to some embodiments of the present disclosure;

FIG. 12 is a view showing still another example of the anchoring device according to some embodiments of the present disclosure;

FIG. 13 is a view for describing a configuration of an anchor unit shown in FIG. 12;

FIGS. 14 to 16 are views for describing yet another example of the anchoring device according to some embodiments of the present disclosure;

FIG. 17 is a view showing a structure of a floor fixing body and an insert body applicable to the rack of FIG. 6;

FIG. 18 is a flowchart for describing an anchoring method according to some embodiments of the present disclosure; and

FIGS. 19A-19E are schematic views showing an anchoring method according to some embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

In some embodiments, a plurality of batteries may be gathered to form an energy storage system (ESS) with expanded voltage and/or current capacity. ESSs may include battery modules/packs used in vehicles or electrical appliances. Regarding the ESS, a rack is used to increase the density of stored energy in an energy storage. The “energy storage” is a space in which the rack is disposed and may include, for example, an allocated space in a container or building. In addition, the rack is a structure into which battery modules may be inserted and in which the battery modules are organized to enable efficient energy storage and management. Such a rack is constructed to be supported by the floor or wall of the energy storage space.

However, the inventor has appreciated that conventional anchoring devices have a disadvantage that anchoring is inconvenient because an anchoring part is positioned inside the rack. For example, when connecting racks or mounting the racks on a wall, a hand does not reach the anchoring part from a second rack excluding a first rack, or there is no work space due to the rack or wall blocking the anchoring part, making anchoring difficult. There is a need for an anchoring device and anchoring method, in which easier construction is possible and a solid state is maintained even when shaking such as an earthquake occurs.

The present disclosure relates to an anchoring device and anchoring method which enable a rack used in an energy storage system (ESS) to be fixed to a floor, and more specifically, to an ESS rack anchoring device and anchoring method.

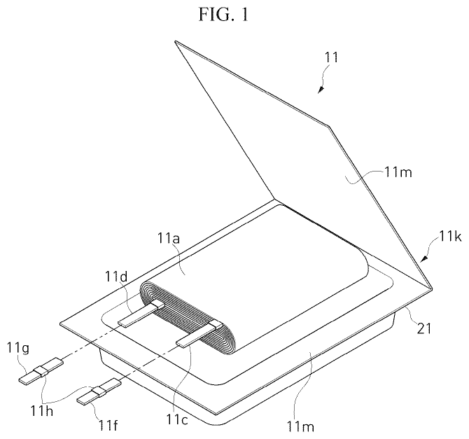

FIG. 1 schematically illustrates a pouch-type secondary battery.

The pouch-type secondary battery 11 includes an electrode assembly 11a and a pouch 11k that accommodates the electrode assembly 11a.

The electrode assembly 11a is illustrated in FIG. 1. A first electrode tab 11c and a second electrode tab 11d of the electrode assembly 11a may be electrically connected to respective external first and second terminal leads 11f and 11g by welding. Each of the first terminal lead 11f and the second terminal lead 11g may be attached with a tab film 11h for insulation from the pouch 11k.

The pouch 11k may be sealed by having sealing parts 11m at the edges thereof come into contact with each other while accommodating the electrode assembly 11a therein, in which case the sealing may be achieved with the tab film 11h interposed between the sealing parts 11m. The sealing parts 11m of the pouch 11k may each be made of a thermal fusion material that generally has weak adhesion to metal. Thus, it may be fused to the pouch 11k by interposing the thin tab film 11h between the sealing parts 11m.

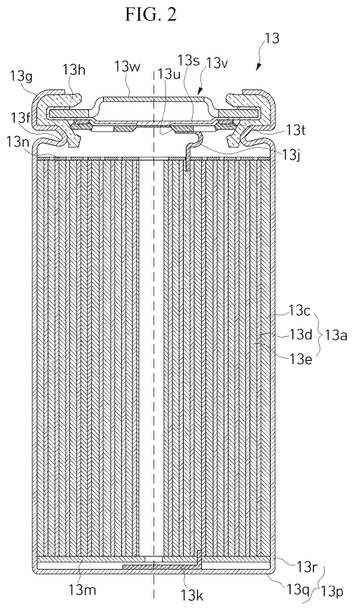

FIG. 2 illustrates a cylindrical secondary battery 13. As shown in FIG. 2, the secondary battery includes an electrode assembly 13a, a case 13p accommodating the electrode assembly 13a and an electrolyte therein, a cap assembly 13v coupled to an opening of the case 13p to seal the case 13p, and an insulating plate 13n positioned between the electrode assembly 13a and the cap assembly 13v inside the case.

The electrode assembly 13a may include a separator 13d and a first electrode 13c and a second electrode 13e positioned with the separator interposed therebetween and may be wound in a jelly-roll shape.

The first electrode 13c may include a first substrate and a first active material layer on the first substrate. A first lead tab 13j may extend outwardly from a first uncoated portion of the first substrate where the first active material layer is not located, and the first lead tab 13j may be electrically connected to the cap assembly 13v.

The second electrode 13e may include a second substrate and a second active material layer on the second substrate. A second lead tab 13k may extend outwardly from a second uncoated portion of the second substrate where the second active material layer is not located, and the second lead tab 13k may be electrically connected to the case. The first lead tab 13j and the second lead tab 13k may extend in opposite directions.

The first electrode 13c may act as a positive electrode. In such an embodiment, the first substrate may be made of, for example, an aluminum foil, and the first active material layer may include, for example, a transition metal oxide. The second electrode 13e may act as a negative electrode. In such an embodiment, the second substrate may be made of, for example, a copper foil or a nickel foil, and the second active material layer may include graphite, for example.

The separator 13d can prevent a short circuit between the first electrode and the second electrode while allowing movement of lithium ions therebetween. The separator 13d may be made of, for example, a polyethylene film, a polypropylene film, a polyethylene-polypropylene film, or the like.

The case 13p may accommodate the electrode assembly 13a and, together with the cap assembly 13v, form the external appearance of the secondary battery. The case 13p may have a substantially cylindrical body portion 13r and a bottom portion 13q connected to one side (e.g., to one end) of the body portion 13r. A beading part 13f (e.g., a bead) deformed inwardly may be formed in the body portion 13r, and a crimping part 13g (e.g., a crimp) bent inwardly may be formed at an open end of the body portion 13r.

The beading part 13f can reduce or prevent movement of the electrode assembly 13a inside the case 13p and can facilitate seating of a gasket 13h and the cap assembly 13v. The crimping part 13g may firmly fix the cap assembly 13v by pressing the edge of the case 13p against the gasket 13h. The case 13p may be formed of iron plated with nickel, for example.

The cap assembly 13v may be fixed to the inside of the crimping part 13g by a gasket 13h to seal the case 13p. The cap assembly 13v may include a cap up 13w, a safety vent 13s, a cap down 13t, an insulating member, and a sub plate 13u but is not limited thereto and may be modified in various ways.

The cap up 13w may be positioned at the uppermost part of the cap assembly 13v. The cap up 13w may include a terminal part that protrudes upwardly and is connected to an external circuit, and an outlet for discharging gas may be arranged around the terminal part.

The safety vent 13s may be located under the cap up 13w. The safety vent 13s may include a protrusion part that protrudes convexly downwardly and is connected to the sub plate 13u, and at least one notch may be formed in the safety vent around the protrusion part.

When gas is generated due to overcharging or abnormal operation of the secondary battery, the protrusion part is deformed upwardly by the pressure and separates from the sub plate 13u while the safety vent 13s is cut (e.g., bursts or tears) along the notch. The cut safety vent 13s may prevent the secondary battery from exploding by allowing for the gas to be discharged to the outside.

The cap down 13t may be below the safety vent 13s. The cap down 13t may have a first opening for exposing the protrusion part of the safety vent 13s and a second opening for gas discharge. The insulating member may be positioned between the safety vent 13s and the cap down 13t to insulate the safety vent 13s and the cap down 13t.

The sub plate 13u may be under the cap down 13t. The sub plate 13u may be fixed to a lower surface of the cap down 13t to block the first opening of the cap down 13t, and the protrusion part of the safety vent 13t may be fixed to the sub plate 13u. The first lead tab 13j, which is drawn out from the electrode assembly 13a may be fixed to the sub plate 13u. Accordingly, the cap up 13w, the safety vent 13s, the cap down 13t, and the sub plate 13u may be electrically connected to the first electrode 13c of the electrode assembly 13a.

The insulating plate 13n may be positioned to be in contact with the electrode assembly 13a below the beading part 13f. The insulating plate 13n may have a tab opening through which the first lead tab 13j is drawn out. The cap assembly 13v, which is electrically connected to the first electrode by the first lead tab, may face the electrode assembly with an insulating plate 13n interposed therebetween and may maintain a state of being insulated (e.g., electrically insulated) from the electrode assembly 13a by the insulating plate 13n. Meanwhile, another insulating plate 13m may be included for insulation between the electrode assembly 13a and the bottom portion 13q of the case 13p.

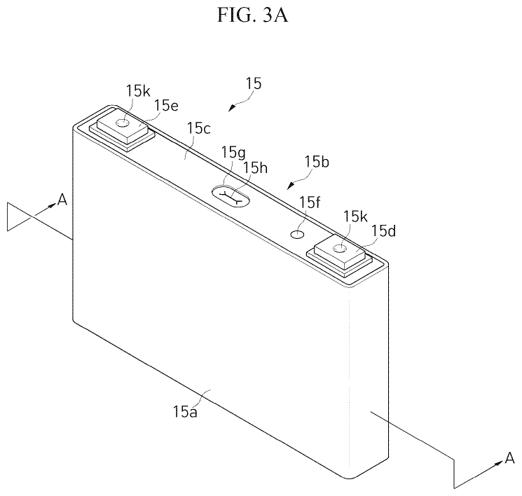

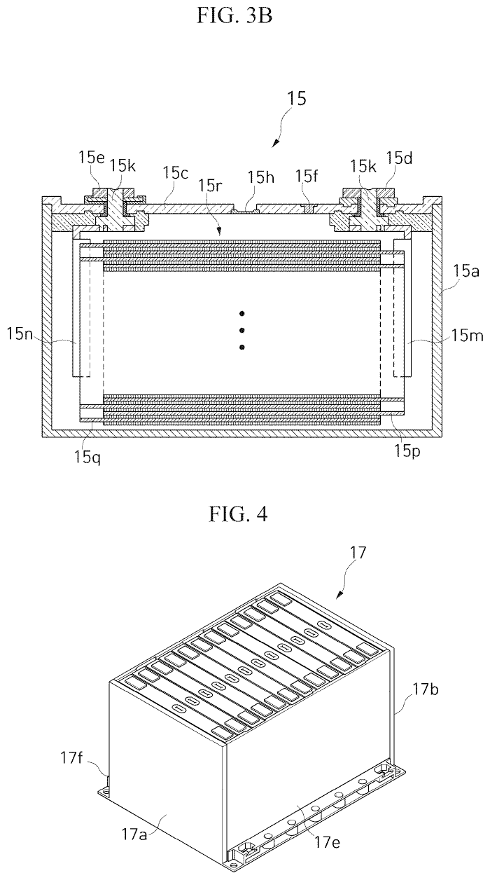

FIG. 3A is a top perspective view of a prismatic secondary battery 15, according to some embodiments of the present disclosure.

A case 15a may define an overall appearance of the prismatic secondary battery, and may be made of a conductive metal, such as aluminum, aluminum alloy, or nickel-plated steel. In addition, the case 15a may provide a space for accommodating an electrode assembly therein.

A cap assembly 15b may include a cap plate 15c that covers the opening of the case 15a. In some examples, the case 15a and the cap plate 15c may be made of a conductive material. Here, a first terminal 15e and a second terminal 15d may be electrically connected to respective positive and negative (or negative and positive) electrodes inside the case, and may be installed to protrude outward through the cap plate 15c.

The cap plate 15c may be equipped with an electrolyte injection port 15f formed to install a sealing plug (or seal pin), and a vent 15h formed with a notch 15g. The vent 15h may be included for discharging gas generated inside the secondary battery.

FIG. 3B is a cross-sectional view taken along the line A-A of FIG. 3A, according to some embodiments of the present disclosure.

As shown in FIG. 3B, a prismatic secondary battery may include an electrode assembly 15r, a first current collector 15m, a first terminal 15e, a second current collector 15n, a second terminal 15d, a case 15a, and a cap assembly 15b.

An electrode assembly 15r may be formed by winding or stacking a stack of a first electrode plate, a separator, and a second electrode plate, which are formed as thin plates or films. When the electrode assembly 15r is a wound stack, a winding axis may be parallel to the longitudinal direction of the case 15a. In some other embodiments, the electrode assembly 15r is a stack type rather than a winding type, and the shape of the electrode assembly 15r is not limited in the present disclosure. In addition, the electrode assembly 15r may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. Of course, the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 15p (e.g., a first uncoated portion) that is a region to which the first electrode active material is not applied. The first electrode tab 15p may act as a current flow path between the first electrode plate and the first current collector 15m. In some embodiments, when the first electrode plate is manufactured, the first electrode tab 15p is formed by being cut in advance to protrude to one side of the electrode assembly 15r, or the first electrode tab 15p protrudes to one side of the electrode assembly 15r more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 15q (e.g., a second uncoated portion) that is a region to which the second electrode active material is not applied. The second electrode tab 15q may act as a current flow path between the second electrode plate and the second current collector 15n. In some embodiments, the second electrode tab 15q may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

The separator can prevent or substantially reduce instances of a short circuit between the first electrode and the second electrode while allowing movement of lithium ions therebetween. The separator may be made of, for example, a polyethylene film, a polypropylene film, a polyethylene-polypropylene film, or the like

In some embodiments, the electrode assembly 15r is accommodated in the case 15a along with an electrolyte.

In the electrode assembly 15r, the first current collector 15m and the second current collector 15n may be welded and connected to the first electrode tab 15p extending from the first electrode plate and the second electrode tab 15q extending from the second electrode plate, respectively. As mentioned above, in some embodiments in which the first electrode tab 15p and the second electrode tab 15q are located at the top of the electrode assembly 15r, the first and second current collectors are located at the top of the electrode assembly 15r.

As illustrated in FIG. 3B, the first current collector 15m and the second current collector 15n are connected to the first terminal 15e and the second terminal 15d through connection members 15k, respectively. In some embodiments, the connection members 15k may each have an outer peripheral surface that is threaded, and may be fastened to the first terminal 15e and the second terminal 15d by screwing. However, the present disclosure is not limited thereto. For example, the connection members 15k may also be coupled to the first terminal 15e and the second terminal 15d by riveting or welding.

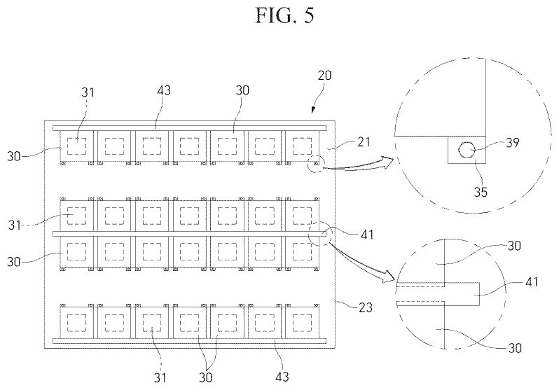

FIG. 4 is a perspective view of a secondary battery module 17 in which secondary batteries are arranged according to embodiments of the present disclosure. With the increase in secondary battery capacity for driving electric vehicles, energy storage system (ESS), or the like, a secondary battery module may be manufactured by arranging a plurality of secondary battery cells transversely and/or longitudinally and connecting them together. The plurality of secondary batteries may be arranged in a space defined by a pair of facing end plates 17a and 17b and a pair of facing side plates 17e and 17f. The secondary batteries may be arranged in an arrangement (e.g., direction) and number to obtain desired voltage and current specifications.

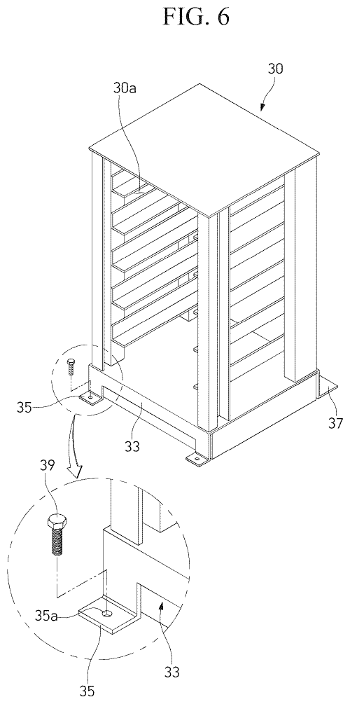

FIG. 5 is a plan view showing one example of the layout of a plurality of racks 30 disposed in an internal space of an energy storage 20.

The energy storage may be a building that provides an internal space capable of accommodating racks. A floor 21 of the energy storage may be made of concrete.

Referring to FIG. 5, it can be seen that the plurality of racks 30 are disposed in a row on the floor 21 of the internal space. It goes without saying that a battery module 31 is stored inside the rack 30. The rack 30 may be fixed to the floor 21 through an ESS anchoring device according to the present embodiments.

As will be described below, the anchoring device may include anchor beams 41 and 43, an insert body 37, and a floor fixing body 35. The anchor beams 41 and 43 may be fixed to the floor 21 and provide support strength. The insert body 37 may be supported without being lifted by the anchor beam. Not being lifted may mean that a state of close contact with the floor 21 is maintained. In addition, the floor fixing body 35 may be a member that is fixed to the floor 21 through a floor fixing part, for example, a fixing bolt 39.

As shown in FIG. 5, the plurality of racks 30 may share one of the anchor beams 41 and 43. For example, the plurality of racks 30 are simultaneously supported by one of the anchor beams 41 and 43.

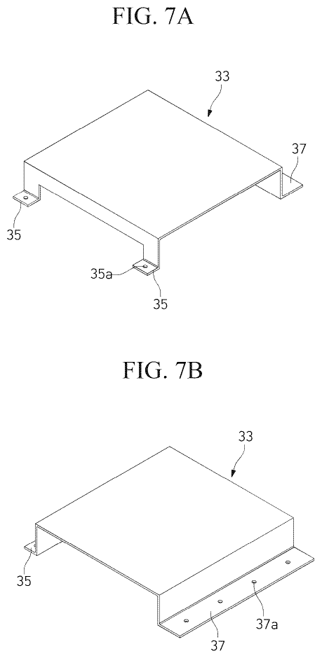

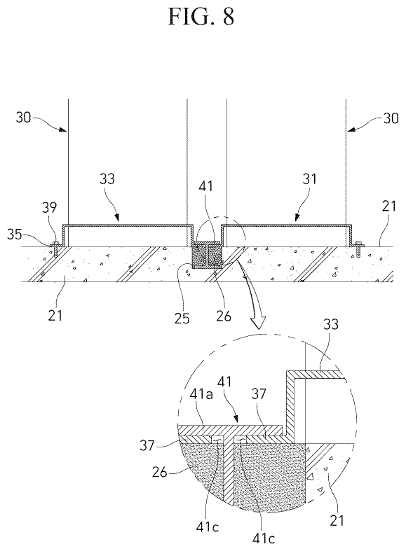

FIG. 6 is a view showing one example of the rack 30 shown in FIG. 5. FIG. 7A is a perspective view showing a fixing structure 33 of FIG. 6. FIG. 7B is another perspective view showing the fixing structure 33 of FIG. 6.

As shown, the rack 30 may provide a module storage part 30a into which the battery module 31 is inserted. In addition, the fixing structure 33 may be applied to a lower end portion of the rack 30. The floor fixing body 35 and the insert body 37 may each be formed at one of both end portions of the fixing structure 33. The floor fixing body 35 and the insert body 37 are members that protrude away from the rack 30. That is, the floor fixing body 35 and the insert body 37 are not hidden in a bottom surface of the rack 30, but are exposed to the outside.

Two floor fixing bodies 35 may be applied, and each may have a bolt hole 35a. The bolt hole 35a is a hole through which the floor fixing part, that is, the fixing bolt 39, passes. The number of floor fixing bodies 35 may vary. A bottom surface of the floor fixing body 35 may be in surface contact with the floor 21. When the floor fixing body 35 is fixed to the floor 21 using the fixing bolt 39 in a state in which the floor fixing body 35 is in surface contact with the floor 21, the fixed state of the rack 30 to the floor 21 is maintained. The floor fixing body may be in contact with the floor in a state in which the insert body is supported by the anchor beam.

The fixing bolt 39 is a component that serves to fix the floor fixing body 35 to the floor 21, and as long as it may fix the floor fixing body 35, another fixing member may be applied instead of the fixing bolt.

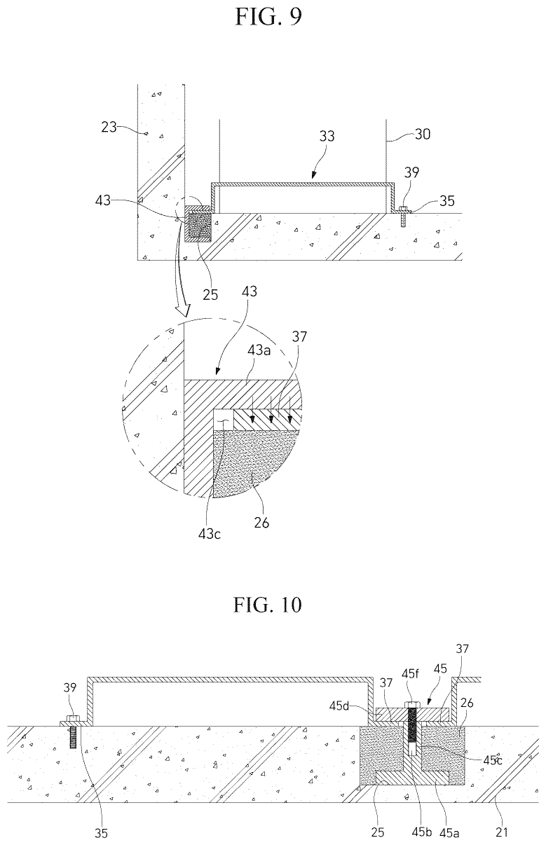

The insert body 37 may be a member positioned at the opposite side of the floor fixing body 35 (e.g., at one side of the rack) and may have a number of through holes 37a. The insert body 37 may be supported by being inserted into restraining spaces 41c (see e.g., FIG. 8) and 43c (see e.g., FIG. 9) provided by the anchor beams 41 and 43. A shape of the insert body 37 may vary as long as it may be supported by being inserted into the restraining space.

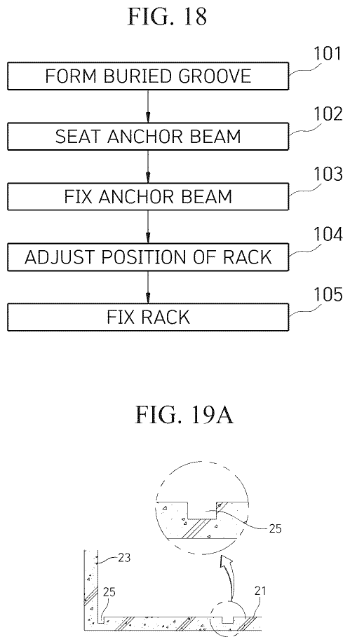

The floor fixing body 35 and the insert body 37 exemplified in FIGS. 7A and 7B are applied to the fixing structure 33 as an integrated part, but may also be applied as a separate part as shown in FIG. 17.

Referring to FIG. 17, it can be seen that lower holders 32a may each be fixed to one of both sides of the lower end portion of the rack 30, and the floor fixing body 35 and the insert body 37 may each be fixed to one of the lower holders 32a.

The lower holder 32a may be a member that detachably supports the floor fixing body 35 and the insert body 37 and may be fixed integrally to a lower end of the rack 30. Two lower holders 32a may be positioned at a front lower end of the rack 30 and one lower holder 32a may be positioned at a rear lower end thereof. In this description, forward is a direction in which the entrance of the battery module is positioned.

The two lower holders 32a installed on the front may be spaced apart from each other. In addition, a dovetail groove 32b may be formed on each lower holder 32a. The dovetail groove 32b may be a vertical extension groove into which a slider 35d of the floor fixing body 35 is inserted. The dovetail groove 32b may have a closed upper portion and an open lower portion.

The floor fixing body 35 may have substantially an L shape and have the slider 35d on a back surface thereof. The slider 35d is supported by the dovetail groove 32b. As described above, since the dovetail groove 32b has the closed lower portion, the floor fixing body 35 is not released downward from the lower holder 32a. Therefore, a load applied to the floor fixing body 35 is applied to the rack 30. In addition, the bolt hole 35a may be formed in the floor fixing body 35. The bolt hole 35a is a hole through which the fixing bolt 39 (see e.g., FIG. 6) may pass.

The lower holder 32a fixed to a rear lower end portion of the rack 30 may extend horizontally and have two dovetail grooves 32b. The dovetail groove 32b may also have a closed lower portion.

In addition, two sliders 37d may be integrally formed in the insert body 37. The slider 37d is inserted into the dovetail groove 32b. The load applied to the insert body 37 may be transmitted to the rack 30.

Meanwhile, the ESS rack anchoring device according to the present embodiments may include the anchor beams 41 and 43, the insert body 37, and the floor fixing body 35.

The anchor beams 41 and 43 are fixed to the floor 21 of the internal space in which the rack 30 is disposed and provide support strength. The anchor beams 41 and 43 in the present embodiments may be shape steel having a predetermined cross-sectional shape in a longitudinal direction and may have an I or ⊂-shaped cross section as shown in FIGS. 8 and 9.

The anchor beam 41 shown in FIG. 8 has an I-shaped cross section, and the anchor beam 43 shown in FIG. 9 has a ⊂-shaped cross section. The anchor beam 41 may have any shape as long as it may press and restrain the insert body 37.

In addition, between the two anchor beams, the anchor beam 43 having the ⊂-shaped cross section may be applied to a corner at which the floor 21 meets a wall 23 as shown in FIG. 9. In contrast, the anchor beam 41 having the I-shaped cross section may be applied at any position. However, the ⊂-shaped anchor beam 43 is preferably disposed at a corner of a lower end portion of the wall 23.

Body pressing portions 41a and 43a are provided on the anchor beams 41 and 43. The body pressing portions 41a and 43a are parts that provide the restraining spaces 41c and 43c between floor surfaces. The floor surface may be a surface of a mortar molded part 26. A surface of the mortar molded part 26 may have the same height as a surface of the floor 21. For example, there is no step between the surface of the mortar molded part 26 and the floor 21.

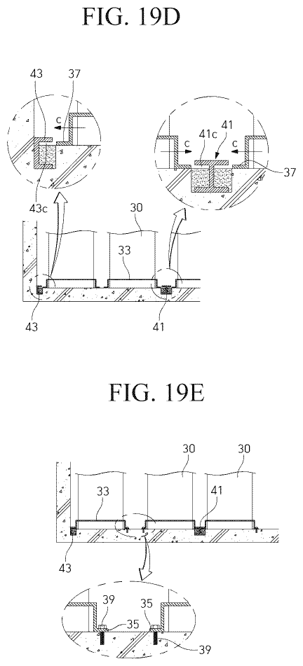

The restraining spaces 41c and 43c may be gap spaces between the surface of the mortar molded part 26 and the body pressing portions 41a and 43a. The insert body 37 may be inserted into the restraining spaces 41c and 43c. The insert body 37 may be inserted into the restraining space 41c by moving horizontally in a direction of arrow c as shown in FIG. 19D. The insert body 37 may be prevented from being lifted by being pressed by the body pressing portions 41a and 43a while being inserted into the restraining spaces 41c and 43c. Heights of the restraining spaces 41c and 43c may correspond to the thickness of the insert body 37. To smoothly insert the insert body 37, the heights of the restraining spaces 41c and 43c and the thickness of the insert body 37 may be adjusted. In some embodiments, the insert body is horizontally formed to protrude outward from the rack to be inserted into the restraining space or withdrawn from the restraining space through a horizontal movement of the rack.

Meanwhile, a plurality of buried grooves 25 may be formed in the floor 21. The buried groove 25 may be a trench-shaped groove, for example, having a predetermined width and depth. The buried groove 25 may be formed when constructing the floor 21. However, when there is no buried groove 25 at a desired point, the buried groove 25 may be formed by being newly dug.

The buried groove 25 may be a space in which the anchor beams 41 and 43 are installed. The reason for forming the buried groove 25 and burying the anchor beams 41 and 43 in the buried groove is to provide the restraining spaces 41c and 43c.

The anchor beams 41 and 43 may be fixedly seated in the buried groove 25. The anchor beams 41 and 43 may not be completely buried in the buried groove 25, but may be seated so that portions of the anchor beams 41 and 43, that is, the body pressing portions 41a and 43a, protrude upward from the floor surface. The restraining spaces 41c and 43c may be secured in the lower portions of the body pressing portions 41a and 43a that protrude upward from the floor surface.

A beam fixing part may be installed inside the buried groove 25. The beam fixing part may serve to fix the anchor beam inside the buried groove 25. In the present embodiments, the beam fixing part may be the mortar molded part 26. The mortar molded part 26 is formed by pouring mortar into the buried groove 25 in which the anchor beams 41 and 43 are installed and may fix the anchor beams 41 and 43. As described above, an upper surface of the mortar molded part 26 after drying may have the same plane as the surface of the floor 21.

FIG. 8 shows a state in which the insert bodies 37 of the rack 30, which are positioned at the opposite sides with the anchor beam 41 interposed therebetween, are supported by the body pressing portion 41a, and the floor fixing body 35 is fixed to the floor 21 by the fixing bolt 39. In addition, FIG. 9 shows a state in which the insert body 37 of the rack 30 positioned in front of the wall 23 is inserted into the lower portion of the body pressing portion 43a of the ⊂-shaped anchor beam 43, and the floor fixing body 35 at the opposite side is fixed to the floor 21 through the fixing bolt 39.

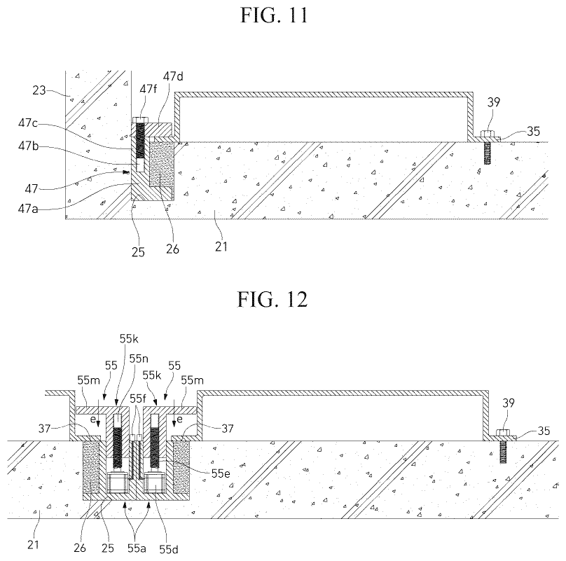

FIGS. 10 and 11 are views showing another example of the anchoring device according to some embodiments of the present disclosure. Since the shape, configuration, and operation effects of the floor fixing body 35 and the insert body 37 in the drawings from FIG. 10 are as described above, description thereof will be omitted.

As shown, assembled anchor units 45 and 47 may be applied to the anchoring device according to other embodiments. The anchor unit may have a base and a supporter. As will be described below, a structure of the base and the supporter may have any suitable configuration.

An anchor unit shown in FIG. 10 may include a ⊥-shaped (i.e., in the shape of half an uppercase I) base 45a, a pressing plate 45d, and a pressing bolt 45f.

The base 45a may be a linear beam extending in the longitudinal direction and may be seated in the buried groove 25. A widthwise central portion of the base 45a may include a holder 45c. The holder 45c is a member having a predetermined thickness and height and may have a female screw hole 45b that opens upward. An upper end portion of the holder 45c may be exposed upward from the mortar molded part 26. An exposed height may correspond to the thickness of the insert body 37. The base 45a may be maintained fixed to the buried groove 25 by the mortar molded part 26. The mortar molded part 26 is a base fixing part for fixing the base.

The pressing plate 45d may be a plate-shaped member having a predetermined width and thickness as one example of the supporter. The pressing plate 45d may be installed horizontally on the holder 45c and fixed to the holder 45c (e.g., an upper end of the holder) through the pressing bolt 45f. The pressing plate 45d may be fixed to the holder and support the insert body 37 holder. The pressing bolt 45f is coupled to the female screw hole 45b through a bolt hole formed in the pressing plate 45d. A space between the pressing plate 45d and the mortar molded part 26 may be a restraining space that accommodates the insert body 37.

As described above, since the base 45a and the pressing plate 45d are implemented in an assembly manner through the pressing bolt 45f, the pressing plate 45d may be replaced. In addition, the insert body 37 may be first positioned on the mortar molded part 26, and then the pressing plate 45d may cover an upper portion of the insert body 37 and fix the insert body 37.

The anchor unit 47 shown in FIG. 11 has an L-shaped base 47a, a pressing plate 47d, and a pressing bolt 47f. The pressing plate 47d is a supporter for supporting the insert body. The base 47a may include a holder 47c that extends upward vertically. A female screw hole 47b to which the pressing bolt 47f is coupled may be formed on the holder 47c. An upper end portion of the holder 47c may protrude upward from the mortar molded part 26. An exposed height may correspond to the thickness of the insert body 37.

When the pressing plate 47d is placed on the upper end portion of the holder 47c and the pressing bolt 47f is fastened, a restraining space may be formed under the pressing plate 47d. FIG. 11 shows a state in which the insert body 37 is inserted into the restraining space.

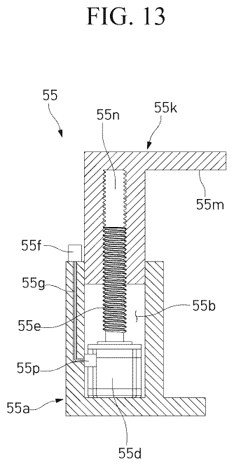

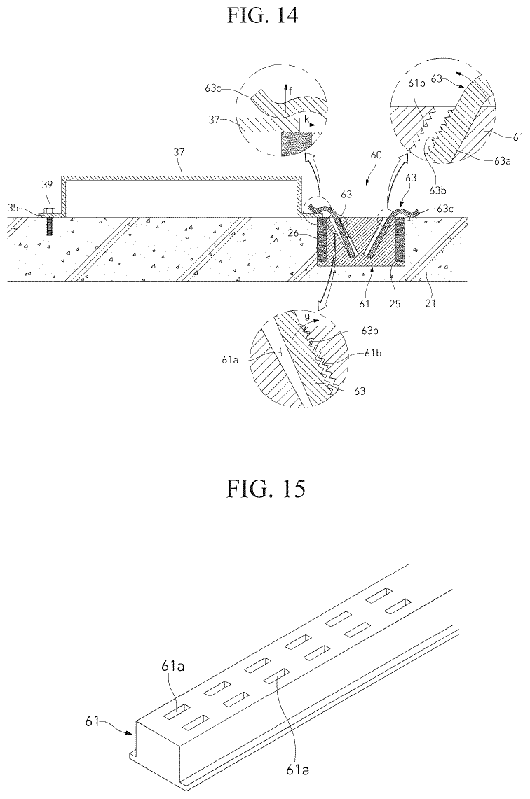

FIG. 12 is a cross-sectional view showing a state in which an anchor unit 55 having a different structure is installed on the floor 21. FIG. 13 is a view separately showing the anchor unit 55.

The anchor unit 55 shown in FIGS. 12 and 13 may include a base 55a having a space portion 55b, an elevating body 55k as a supporter, an elevating mechanism, and a communication module. A single anchor unit 55 or two anchor units 55 may be installed in the buried groove 25. The single anchor unit 55 may serve as the ⊂-shaped anchor beam 43. In addition, the two anchor units may serve as the ‘I’-shaped anchor beam 41.

The base 55a is a member that extends linearly in the longitudinal direction and may provide a space portion 55b that opens upward. The space portion 55b may accommodate an elevating mechanism (e.g., an electric elevating mechanism).

The elevating body 55k is a member that may move upward and downward on the base 55a with a portion thereof accommodated in the space portion 55b. The elevating body 55k may move upward and downward while maintaining horizontality. A female screw hole 55n with an open lower portion may be formed in the elevating body 55k. The female screw hole 55n may be a female screw hole into which a lead screw 55e included in the elevating mechanism is engaged. In addition, a pressing part 55m may be formed at an upper portion of the elevating body 55k. The pressing part 55m presses and supports the insert body 37 in a state in which the elevating body 55k has moved downward in a direction of arrow e of FIG. 12. The pressing part may be a part of an anchor module configured to support the insert body. The pressing part (or pressing portion) may be configured to press and support the insert body and may be provided on a side portion of the elevating body.

The elevating mechanism may move the elevating body 55k downward so that the pressing part 55m may support the insert body 37. The elevating mechanism may be an electric type. That is, the elevating mechanism may be operated by a control signal transmitted from the outside.

The elevating mechanism may include a motor 55d, a motor controller 55p, and the lead screw 55e. The motor 55d may be driven by the motor controller 55p. The electric elevating mechanism configured to move the elevating body upward and downward may be installed in the space portion of the base.

In addition, the motor controller 55p may be connected to the communication module 55f through a cable 55g. The communication module 55f transmits the control signal input from the outside to the motor controller 55p. The motor controller 55p adjusts a height of the elevating body 55k based on the signal received from the communication module 55f. The communication module 55f may be connected to an administrator terminal in a wireless manner. An administrator may be a construction worker who constructs the rack 30. In addition, the terminal may be a smartphone of the construction worker. The communication module may be configured to access the elevating mechanism and transmit an external control signal to a motor controller to adjust a height of the elevating body.

The motor 55d may be mounted inside the space portion 55b and may rotate the lead screw 55e in both directions. The lead screw 55e is installed vertically and engaged with the female screw hole 55n of the elevating body 55k. As a result, the administrator may remotely adjust the height of the elevating body 55k using his or her smartphone. In some embodiments, the lead screw may be axially rotated by receiving a rotational force of the motor.

To install the rack 30 using the anchor unit 55 having the above configuration, first, the elevating body 55k is moved upward. Thereafter, the rack 30 is moved to position the insert body 37 vertically under the pressing part 55m. When the above process is finished, the elevating body 55k is moved downward so that the pressing part 55m presses and supports the insert body 37.

The anchor unit 55 having the above configuration may be fixed to the mortar molded part 26 while being seated in the buried groove 25. An upper end portion of the base 55a may have the same height as the upper surface of the mortar molded part 26. The upper end portion of the base 55a may be positioned on the same plane as the floor 21.

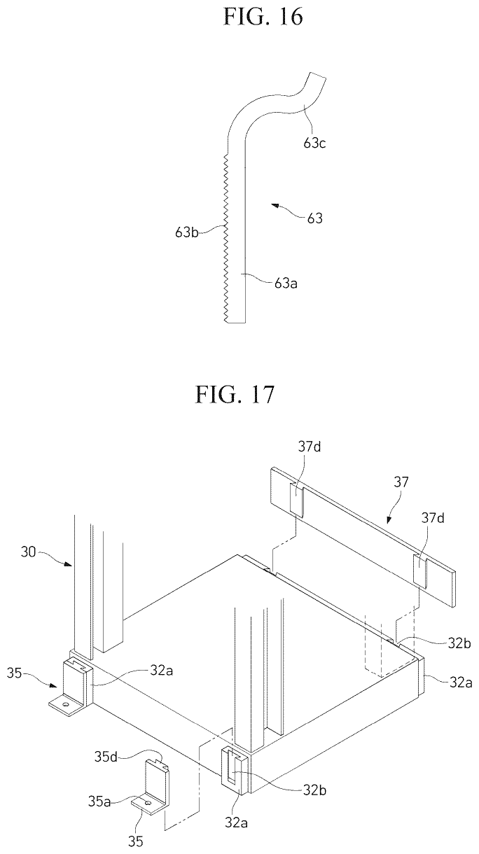

An anchor unit 60 shown in FIG. 14 has a base 61 having a plurality of fixing holes 61a and a plurality of elastic pressing plates 63. FIG. 15 is another view for showing the base 61 of the anchoring device

The base 61 is a block-shaped member that extends linearly. The base 61 may be fixed to the mortar molded part 26 while being seated in the buried groove 25 (e.g., the base may be fixed to the floor). The fixing hole 61a is a hole that opens upward and may be arranged in two rows in a longitudinal direction of the base 61. The upper end portion of the base 61 is positioned on the same plane as the floor 21.

As shown in FIG. 14, a pair of fixing holes 61a formed at the left and right of the base 61 may be symmetrically inclined away from each other from the bottom to the top. In addition, a support sawteeth portion 61b may be formed inside each fixing hole 61a. The support sawteeth portion 61b may be a part corresponding to a locking sawteeth portion 63b of the elastic pressing plate 63, and may be engaged with the support sawteeth portion 61b when an elastic pressing portion 63c to be described below is pressed in a direction of arrow f to prevent the elastic pressing plate 63 from being pulled out upward.

The elastic pressing plate 63 is a supporter for pressing and supporting the insert body 37. The elastic pressing plate 63 may be installed such that a position thereof is adjustable on the base 61 and may provide support strength. The elastic pressing plate may be formed of an elastically deformed metal member. The supporter may be an elastic pressing plate of which a portion elastically presses and supports the insert body from an outside area of the base while being supported by the fixing hole.

As shown in FIG. 16, the elastic pressing plate 63 may include an extension 63a and the elastic pressing portion 63c. The elastic pressing plate may have an extension supported by being accommodated in the fixing hole.

The extension 63a is a linear extending part and may have the locking sawteeth portion 63b on one side surface thereof. The extension 63a may be detachably inserted into the fixing hole 61a. The extension 63a may move while being inserted into the fixing hole 61a. In a state in which the extension 63a is inserted into the fixing hole 61a, the locking sawteeth portion 63b and the support sawteeth portion 61b are only opposed and are not engaged.

The elastic pressing portion 63c is a curved portion that is integrally formed with an upper end of the extension 63a and is bent as shown in FIG. 14, and is a portion that is pressed in the direction of arrow f by the insert body 37 that enters in a direction of arrow k. When the extension 63a moves upward, the elastic pressing plate 63 moves in a direction of arrow g so that the locking sawteeth portion 63b may be engaged with the support sawteeth portion 61b. The fixed state of the elastic pressing plate 63 is maintained by such engagement. In addition, the insert body 37 is restrained by a reaction force of the elastic pressing portion 63c and therefore is not lifted.

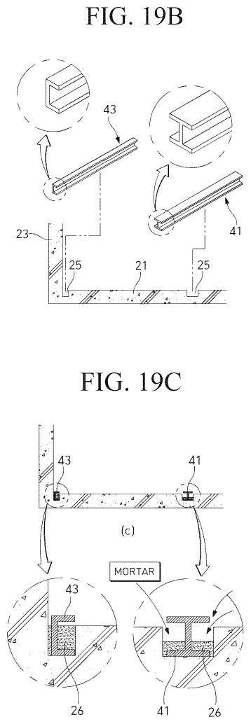

FIG. 18 is a flowchart for describing an anchoring method according to some embodiments of the present disclosure. FIGS. 19A-19E are each a schematic view showing the anchoring method according to some embodiments of the present disclosure.

As shown, the rack anchoring method according to the present embodiments includes a buried groove forming operation 101 (e.g., form buried groove), an anchor beam seating operation 102 (e.g., seating or installing an anchor beam), an anchor beam fixing operation 103 (e.g., fix anchor beam), a rack position adjusting operation 104 (e.g., adjust position of rack), and a rack fixing operation 105 (e.g., fix rack).

The buried groove forming operation 101 may be a process of forming the buried groove 25 having a predetermined depth on the floor 21 on which the rack 30 is installed. Through the buried groove forming operation 101, the buried groove 25 shown in FIG. 19A may be secured.

Then, the anchor beam seating operation 102 is a process of seating the anchor beams 41 and 43 in the secured buried groove 25. The above-described ⊂-shaped anchor beam is disposed at the corner at which the wall 23 meets the floor, and the I-shaped anchor beam is seated in another buried groove 25. In this case, the body pressing portions 41a and 43a of the anchor beams protrude upward from the buried groove 25 (see e.g., FIG. 19B).

The anchor beam fixing operation 103 is a process of fixing the anchor beam in the buried groove. The anchor beam fixing operation 103 may be a process of pouring mortar into the buried groove 25 in which the anchor beam is fixed (or seated). In particular, the pouring may be performed such that the upper surface of the mortar molded part 26 after drying is positioned on the same plane as the floor 21 as shown in FIG. 19C.

The rack position adjusting operation 104 is a process of adjusting the position of the rack 30 with respect to the fixed anchor beams 41 and 43. For example, the rack position adjusting operation is a process of moving the rack 30 so that the insert body 37 is positioned right in front of the restraining spaces 41c and 43c. The insert body 37 after the rack position adjusting operation 104 is completed waits right in front of the restraining spaces 41c and 43c.

Then, the rack fixing operation 105 may be a process of pushing and moving the rack 30 in the direction of arrow c of FIG. 19D so that the insert body 37 is accommodated in the restraining spaces 41c and 43c, and in that state, fixing the floor fixing body 35 to the floor 21 using the fixing bolt 39 (see e.g., FIG. 19E). Through such a process, the insert body 37 may be supported by being pressed by the anchor beam to prevent lifting, and the floor fixing body 35 at the opposite side may be fixed to the floor 21. The anchoring operation is completed through this operation. In some embodiments, the floor fixing body may be in contact with the floor in a state in which the insert body is supported by an anchor module.

According to an ESS rack anchoring device and anchoring method of the present disclosure, an anchoring process of a rack can be simple, and a plurality of racks can be consecutively disposed densely. In addition, it is possible to stably maintain the rack even when shaking such as an earthquake occurs because a strong fixation to the floor is maintained.

Although the present disclosure has been described above with respect to embodiments thereof, the present disclosure is not limited thereto. Various modifications and variations can be made thereto by those skilled in the art within the spirit of the present disclosure.

What is claimed is:

1. An energy storage system (ESS) rack anchoring device comprising:
an anchor beam fixed to a floor of a space in which a rack for accommodating a battery module is disposed and configured to provide support strength;
an insert body positioned at one side of the rack and supported by being pressed by the anchor beam to prevent lifting;
a floor fixing body in contact with the floor in a state in which the insert body is supported by the anchor beam; and
a floor fixing part fixing the floor fixing body to the floor.

2. The ESS rack anchoring device as claimed in claim 1, wherein the anchor beam has a body pressing portion that provides a restraining space between the body pressing portion and a floor surface of the floor and is configured to support the insert body accommodated in the restraining space.

3. The ESS rack anchoring device as claimed in claim 2, wherein the insert body is horizontally formed to protrude outward from the rack to be inserted into the restraining space or withdrawn from the restraining space through a horizontal movement of the rack.

4. The ESS rack anchoring device as claimed in claim 2, wherein:
a buried groove is formed in the floor of the space,
the anchor beam is seated in the buried groove and seated so that the body pressing portion protrudes upward from the buried groove, and
a beam fixing part fixing the anchor beam in the buried groove is provided in the buried groove.

5. The ESS rack anchoring device as claimed in claim 1, wherein the anchor beam has one of I-shaped and ⊂-shaped cross sections, wherein the ⊂-shaped cross section includes a C shape with sharp corners.

6. An energy storage system (ESS) rack anchoring device comprising:
an anchor unit having a base fixed to a floor of a space in which a rack for accommodating a battery module is disposed and a supporter installed such that a position thereof is adjustable on the base and configured to provide support strength;
an insert body fixed to one side of the rack and supported by an anchor module to prevent lifting from the floor;
a floor fixing body in contact with the floor in a state in which the insert body is supported by the anchor module; and
a floor fixing part fixing the floor fixing body to the floor.

7. The ESS rack anchoring device as claimed in claim 6, wherein:
the base is a beam extending in a longitudinal direction and bas a holder, and
the supporter is a pressing plate that is disposed horizontally on the holder and supports the insert body while being fixed to an upper end of the holder through a pressing bolt.

8. The ESS rack anchoring device as claimed in claim 7, wherein:
a buried groove is formed in the floor of the space,
the base of the anchor unit is seated in the buried groove and seated so that an upper end portion of the holder protrudes upward from the buried groove, and
a base fixing part fixing the base in the buried groove is provided inside the buried groove.

9. The ESS rack anchoring device as claimed in claim 6, wherein:
the base provides a space portion that opens upward,
the supporter comprises an elevating body that is movable upward and downward on the base in a state in which a portion thereof is accommodated in the space portion, and
an electric elevating mechanism configured to move the elevating body upward and downward is installed in the space portion of the base.

10. The ESS rack anchoring device as claimed in claim 9, wherein:
a pressing portion configured to press and support the insert body is provided on a side portion of the elevating body, and
the elevating mechanism is configured to move the elevating body downward so that the pressing portion supports the insert body.

11. The ESS rack anchoring device as claimed in claim 9, wherein:
the elevating mechanism has a motor, a motor controller configured to control the motor, and a lead screw axially rotated by receiving a rotational force of the motor and installed vertically, and
a female screw hole configured to engage with the lead screw is provided in the elevating mechanism.

12. The ESS rack anchoring device as claimed in claim 9, wherein the anchor unit is further provided with a communication module which is configured to access the elevating mechanism and transmit an external control signal to a motor controller to adjust a height of the elevating body.

13. The ESS rack anchoring device as claimed in claim 9, wherein:
a buried groove is formed in the floor of the space, and the base is seated in the buried groove, and
a base fixing part is provided in the buried groove to fix the base, wherein an upper end portion of the base is positioned on a same plane as the floor.

14. The ESS rack anchoring device as claimed in claim 6, wherein:
the base has a shape of a linearly extending block, and has a fixing hole that opens upward, and
the supporter is an elastic pressing plate of which a portion elastically presses and supports the insert body from an outside area of the base while being supported by the fixing hole.

15. The ESS rack anchoring device as claimed in claim 14, wherein:
a support sawteeth portion is formed inside the fixing hole, and
the elastic pressing plate has an extension supported by being accommodated in the fixing hole, and an elastic pressing portion that is formed integrally with an upper end of the extension, has a bent shape, and supports the insert body.

16. The ESS rack anchoring device as claimed in claim 14, wherein:
a buried groove is formed in the floor of the space,
the base is seated in the buried groove, and
a base fixing part is provided in the buried groove to support the base; and
wherein an upper end portion of the base is positioned on a same plane as the floor.

17. An anchoring method comprising:
forming a buried groove, wherein the buried groove is formed in a floor of a space in which a rack for accommodating a battery module is disposed;
installing an anchor beam in an anchor beam seating operation in which the anchor beam providing support strength is installed in the buried groove;
fixing an anchor beam, wherein the anchor beam is fixed in the buried groove;
adjusting a rack position, wherein a position of the rack with respect to the fixed anchor beam is adjusted; and
fixing the rack, wherein the rack of which the position is adjusted is moved to the anchor beam to support the rack on the anchor beam.

18. The anchoring method as claimed in claim 17, wherein an insert body is provided on one side of a lower end portion of the rack, and a floor fixing body coupled to the floor is installed on the other side thereof, and
fixing the rack comprises a process of installing the floor fixing body on the floor in a state in which the insert body is supported by being engaged with the anchor beam.

19. The anchoring method as claimed in claim 17, wherein fixing the anchor beam comprises a process of pouring mortar in the buried groove in which the anchor beam is seated.
